(19) United States
(12) Patent Application Publication
(10) Pub. No.: US 2023/0192241 A1
(43) Pub. Date: Jun. 22, 2023

(54) FLOATABLE OFFSHORE STRUCTURE

(71) Applicant: Jörn Runge, Marklohe (DE)

(72) Inventor: Jörn Runge, Marklohe (DE)

(73) Assignee: RWE Renewables GmbH, Essen (DE)

(21) Appl. No.: 18/170,995

(22) Filed: Feb. 17, 2023

Related U.S. Application Data
(63) Continuation of application No. PCT/EP2021/072577, filed on Aug. 13, 2021.

(30) Foreign Application Priority Data
Sep. 8, 2020 (DE) 10 2020 123 374.4

(51) Int. Cl. B63B 21/50; B63B 39/03; B63B 21/16; F03D 13/25

(52) U.S. Cl. CPC B63B 21/502; B63B 39/03; B63B 21/16; F03D 13/25; F05B 2270/342; B63B 2207/02; B63B 2035/446

(57) ABSTRACT

A floatable offshore structure, in particular a floatable offshore wind turbine, includes at least one floatable foundation with at least one floating body. The offshore structure further includes at least one anchoring arrangement configured to fix the offshore structure to an underwater ground in an anchoring state of the offshore structure. The anchoring arrangement includes at least one anchor connection between an anchor and the floatable foundation and at least one position stabilization device configured to change the length of the anchor connection between the anchor and the floatable foundation in the anchoring state based on at least one attitude parameter of the offshore structure and at least one attitude set point parameter.

### CROSS-REFERENCE TO RELATED PATENT APPLICATIONS

This patent application is a continuation of International Application No. PCT/EP2021/072577, filed on Aug. 13, 2021, which claims the benefit of priority to German Patent Application No. 10 2020 123 374.4, filed Sep. 8, 2020, the entire teachings and disclosures of both applications are incorporated herein by reference thereto.

### FIELD

The application relates to a floatable offshore structure, in particular a floatable offshore wind turbine, comprising at least one floatable foundation comprising at least one floating body, and at least one anchoring arrangement configured to fix the offshore structure to an underwater ground in an anchoring state of the offshore structure, wherein the anchoring arrangement comprises at least one anchor connection extending between an anchor and the floatable foundation. In addition, the application relates to an offshore system, a method, and an offshore set.

### BACKGROUND

Wind energy systems and wind farms, respectively, with at least one wind turbine are increasingly being used to provide electrical energy from so-called renewable energy sources. A wind turbine is configured in particular to convert the kinetic wind energy into electrical energy.

In order to increase the energy yield of such systems, wind farms are increasingly located at sites with a high wind probability. Offshore locations in particular are usually characterized by relatively continuous wind conditions and high average wind speeds so that so-called offshore wind energy systems and offshore wind farms, respectively, are increasingly being installed.

Usually, an offshore wind farm comprises a plurality of offshore structures, such as a plurality of offshore wind turbines and at least one offshore substation by which the offshore wind farm is electrically connected, for example, to an onshore substation or a further offshore substation and offshore converter station, respectively.

An onshore substation, in turn, may be connected to a public power grid. In order to transmit electrical energy between two offshore structures or an offshore structure and an onshore structure power cables are laid in the form of submarine cables.

While it has been common practice for offshore wind turbines and offshore substations, but also for other offshore structures such as platforms for gas or oil exploration, to anchor them by means of a foundation structure (e.g. monopile, tripod, tripile, or jacket foundations) on respectively in the underwater ground, in particular a seabed, there are increasing considerations to install floating offshore structures, for example floating offshore wind turbines, in order to install offshore structures, in particular offshore wind farms, in particular in regions with a large water depth, for example of more than 150 meters.

A floatable respectively floating offshore structure comprises at least one floatable foundation with at least one floating body. An apparatus, such as a platform, substation, wind power device, etc., may be installed on the floatable foundation.

For a (permanent) stationary operation of the offshore structure, the offshore structure is fixed to the underwater ground (usually a seabed) by at least one anchoring arrangement. The at least one anchoring arrangement is configured to fix the offshore structure to an underwater ground in an anchoring state of the offshore wind turbine. For this purpose, the anchoring arrangement comprises at least one anchor connection extending between an anchor that is at least partially buried in the underwater ground and the floatable foundation.

Due to the floating design of such an offshore structure, the offshore structure is movable by wind and/or waves. In particular, floating offshore structures may experience a significant (periodic) tilting movement, in particular in the main wind direction and/or main wave direction. In order to prevent damages of in particular the offshore apparatus arranged on the floatable foundation, in the prior art an elaborate design of the floatable foundations and in particular a relatively deep vertical positioning of an offshore structure during installation are carried out.

In particular, the relatively deep vertical positioning of an offshore structure during installation means that the power yield of an offshore wind turbine is reduced, in particular at low wind speeds, as wind speeds are generally greater at higher altitudes.

In addition, even at medium wind speeds and/or medium wave heights, a tilting movement or swaying movement occurs that makes it at least considerably more difficult for an aircraft or watercraft to land at the offshore structure. Landing may even not be possible.

### BRIEF SUMMARY

Therefore, the object of the application is to provide an offshore structure for which the disadvantages of the prior art are at least reduced and, in particular, a landing at the offshore structure is possible even under unfavorable meteorological conditions.

The problem is solved according to a first aspect of the application by a floatable offshore structure, in particular a floatable offshore wind turbine. The offshore structure comprises at least one floatable foundation comprising at least one floating body. The offshore structure comprises at least one anchoring arrangement configured to fix the offshore structure to an underwater ground in an anchoring state of the offshore structure. The anchoring arrangement comprises at least one anchor connection extending between an anchor and the floatable foundation. The offshore structure comprises at least one attitude stabilization device configured to change the length of the anchor connection between the anchor and the floatable foundation in the anchoring state based on at least one attitude parameter of the offshore structure and at least one attitude set point parameter.

In contrast to the prior art, according to the application a floatable offshore structure is provided in which the disadvantages of the prior art are at least reduced by providing a position stabilization device which stabilizes the position of the floatable offshore structure by changing the length of the anchor connection between the anchor and the floatable foundation. In particular, a landing at the offshore structure can at least be facilitated by changing the length of the anchor connection between the anchor and the floatable foundation, in particular by shortening or lengthening it at least during the landing process. It has been recognized that this can at least reduce the tilting movement or swaying movement of an offshore structure.

In a preferred floatable offshore wind turbine, it is also possible to increase the power yield and energy yield, respectively, by changing the length of the anchor connection between the anchor and the floatable foundation.

The offshore structure according to the application is a floatable offshore structure, such as an offshore wind turbine, an offshore substation, an offshore platform for gas or oil exploration and the like. An offshore structure comprises at least one floatable foundation on which, in particular, an offshore apparatus may be arranged.

In a preferred embodiment, the offshore structure is an offshore wind turbine. On the at least one foundation of an offshore wind turbine, in particular as an offshore apparatus, a wind power apparatus is arranged, comprising tower, nacelle, rotor, generator, etc.

The at least one floatable foundation comprises at least one floating body. A floating body or buoyancy body is independently buoyant in particular due to its buoyancy by displacement according to Archimedes' principle. Floating bodies may, for example, be hollow and filled with air or with a light solid material. In particular, the floatable foundation may substantially form the floating body.

The floatable foundation may preferably be a so-called barge foundation, semi-submersible foundation, spar foundation and/or tension leg platform (TLP) foundation. It shall be understood that other types of floatable foundations may be provided in other variants of the application.

According to the application, a floatable foundation is fixed and anchored, respectively, to the underwater ground by means of at least one anchoring arrangement. In particular, a plurality (e.g., three or four) of anchoring arrangements may be provided for the fixation.

An anchoring arrangement according to the application comprises an anchor connection, in particular in the form of an anchor rope or an anchor chain. One end of the anchor connection is attached to the foundation and the other end is attached to at least one anchor (e.g., weight anchor, torpedo anchor, etc.). The anchor may be at least partially buried in the underwater ground.

The condition in which the foundation, and thus the offshore structure, is fixed to the underwater ground by the at least one anchoring arrangement is referred to herein in particular as the anchoring state of the foundation and the offshore wind turbine, respectively.

According to the application, it has been recognized that critical positions of the offshore structure, in which at least damages of the offshore structure is imminent, can at least be reduced if a possibility is provided to change the length of an anchor connection of an anchoring arrangement in the anchoring state, i.e. in the intended operation of the offshore structure. In particular, by shortening (but possibly also by lengthening) the length, a tilting movement or swaying movement of the offshore structure is at least reduced compared to a longer length (and smaller length, respectively).

In order to change the length, it is proposed according to the application to provide an attitude stabilization device. This may be at least partially arranged in and/or on the floatable foundation. In variants of the application, this may also be at least partially arranged in the offshore apparatus, such as a tower of an offshore wind turbine.

According to the application, the at least one attitude stabilization device is configured to change the length of the anchor connection between the anchor and the floatable foundation (in particular the point at which the anchor connection reaches the foundation) in the anchoring state based on at least one (provideable) attitude parameter of the offshore structure and at least one (predefined) attitude set point parameter.

An attitude parameter (value) of the offshore structure is in particular a position parameter directly and indirectly describing the (current and/or predicted future) vertical position and/or horizontal position of the offshore structure. The at least one attitude parameter specifies in particular a vertical position and/or horizontal position of the offshore structure to be set.

In particular, two or more attitude parameters and/or (corresponding to the attitude parameters) two or more attitude set point parameters may be provided. Preferably, a plurality of different attitude parameters, e.g. in the form of an attitude parameter data set, and a corresponding plurality of (predefined) attitude set point parameters, e.g. in the form of a corresponding attitude set point parameter data set, can be provided.

Preferably, the attitude stabilization device may comprise at least one control module configured to control the changing of the length of the anchor connection between the anchor and the floatable foundation based on the at least one attitude parameter of the offshore structure and at least one attitude set point parameter. For example, the control module may be provided with at least one suitable controller.

This means in particular that the length is changed in such a way that the (current and/or predicted future) attitude parameter (essentially) corresponds to the attitude set point parameter, a possible difference is minimized.

In the event that the attitude set point parameter is a limit value of an impermissible attitude range or permissible attitude range, variants of the application may provide that the length is changed in such a way that the (current and/or predicted future) attitude parameter is at least within the permissible attitude range, i.e. does not exceed (or fall below) the attitude set point (limit) parameter.

According to a preferred embodiment of the offshore structure according to the application, the attitude stabilization device may comprise at least one winch device coupled to the anchor connection. The winch device may be configured to change the length of the anchor connection between the anchor and the floatable foundation. In particular, the winch device comprises a substantially cylindrical and rotatable drum.

In the present case, coupled means in particular that the at least one anchor connection in the form of an anchor rope or an anchor chain can be wound and unwound on the drum (in particular between a minimum and maximum length). One end of the anchor connection can be firmly attached to the drum or another attachment point of the winch device.

Preferably, the winch device can comprise at least one controllable and motor-based drive, in particular an electric motor that can be supplied with electrical energy from the offshore structure. The drive can be controlled by the control module in particular in such a way that the length is changed in such a way that the at least one (current and/or predicted future) attitude parameter (substantially) corresponds to the at least one attitude set point parameter or at least lies within the permissible attitude range.

According to a further embodiment of the offshore structure according to the application, the winch device may comprise at least one parking brake. The parking brake may be releasable to change the length of the anchor connection (and lockable after the change). When a change in the length of the anchor connection is to be made, for example, the control module can control the parking brake so that it is released. Then, in particular by the drive, the length of the anchor connection can be changed as described. Subsequently, the parking brake can be locked (again) automatically or by a renewed control by e.g. the control module. This can reduce the load on the drive.

The at least one attitude parameter may be provided to the attitude stabilization device by an apparatus not comprised by the offshore structure. Furthermore, according to a preferred embodiment of the offshore structure according to the application, the offshore structure may comprise at least one attitude detecting device configured to detect the at least one attitude parameter of the offshore structure. In other words, in this embodiment, the offshore structure, in particular an actual attitude parameter of the offshore structure, can be determined by the attitude detecting device itself. In particular, a control of a winch device or another device (e.g., ballast medium conveying arrangement, lifting device), in particular of the at least one drive, can be performed depending on a difference between the detected attitude parameter and actual attitude parameter, respectively, and the (predetermined) attitude set point parameter.

The at least one attitude parameter may be, in particular, at least one attitude angle (also called Euler angle) of the offshore structure. For example, the at least one attitude parameter may be a yaw angle (angle between the current orientation of the offshore structure and the vertical axis (also called z-axis)), a roll angle (angle between the current orientation of the offshore structure and a longitudinal axis (also called x-axis)), and/or a pitch angle (angle between the current orientation of the offshore structure and a longitudinal axis (also called y-axis)).

Preferably, the attitude detecting device can be a tilt angle detecting device configured to detect the tilt angle of the offshore structure. In particular, the tilt angle is the (maximum) angle (in a reversal position) related to a vertical axis respectively direction during a tilting movement or swaying movement of the offshore structure. For example, a (maximum) tilt angle, preferably a permissible tilt angle range, can be provided as an attitude set point parameter. If the actual tilt angle is outside the permissible tilt angle range, in particular the length can be changed in such a way (in particular for such a long time) that (until) the detected tilt angle is again within the permissible range.

Alternatively or additionally, the attitude detecting device may be a tilt frequency detecting device configured to detect the tilt frequency of the offshore structure. It shall be understood that the detecting of the tilt frequency comprises a detecting of the tilt period duration. Analogous to the explanations regarding the tilt angle, a control can be performed.

In a preferred embodiment of the offshore structure according to the application, at least a first selectable attitude set point parameter for a first (desired) attitude state of the offshore structure and a second selectable attitude set point parameter for a second (desired) attitude state of the offshore structure may be provided. The first attitude state may be different from the second attitude state.

For example, a first attitude state may be a (normal) operating state and a second attitude state may be a landing state. During normal operation, a stronger tilting movement or swaying movement may be permissible (corresponding to a predetermined first attitude state and a first movement set point parameter (data set), respectively). During a landing process, on the other hand, only a slight tilting movement or swaying movement may be permissible (corresponding to a predetermined second position state and a second position set point parameter(s), respectively). In particular, the respective at least one attitude set point parameter can be selectable (for example, by the user who wants to land) and, in particular, can be predefined for the control module.

In further variants of the application, further or other selectable attitude set parameters may be provided for further or other attitude states. For example, a maintenance state with at least one respective attitude set point parameter can be provided, which can be selected (after a landing) for a maintenance operation.

For example, it may be provided that at least one minimum attitude parameter (data set) is stored locally in an offshore structure. This can ensure that a specific minimum stable position (and condition, respectively) of the offshore structure is always maintained. The actual position of the offshore structure can then be set within the allowable range, in particular (for offshore wind turbines) such that the energy yield of the offshore wind farm is maximized.

According to a further embodiment of the offshore structure according to the application, at least one vertical anchor connection extending substantially in vertical direction may be attached to the floatable foundation. At least one angle anchor connection extending at an angle to the vertical direction of at least 2°, preferably at least 5° (and at most 45°), may be attached to the floatable foundation. The attitude stabilization device may be configured to change the length of the vertical anchor connection and/or the angle anchor connection based on at least one attitude parameter of the offshore structure. In particular, depending on the at least one attitude parameter and the at least one attitude set point parameter, it may be advantageous if the respective length of the vertical anchor connection(s) and the angle anchor connection(s) are changed differently.

If, in particular, the vertical plane in which the angle of the angle anchor connection to the vertical direction (vertical axis) lies extends in a direction parallel to the main wind direction and/or main wave direction (or in a range ±20°) (and, in particular, the anchor of this angle anchor connection is located on the wind- and/or wave-impacting side), it can be predetermined, in particular by the at least one attitude set point parameter, that the anchor connection of said angle anchor connection is shortened more (e.g. 2 to 10 m more) than the at least one vertical anchor connection, in particular in such a way that without wind and waves an inclination in the direction of the main wind direction and/or main wave direction would result. Additionally or alternatively, it could be provided that for at least one further angle anchor connection, at which the anchor is on the side facing away from the wind and/or waves, the length is left unchanged or lengthened so that without wind and waves an inclination in the direction of the main wind direction and/or main wave direction would result.

As already described above, the attitude parameter (and attitude set point parameter) may be an attitude parameter directly indicating the attitude of the offshore structure, such as the attitude parameters described previously. Alternatively or additionally, the attitude parameter may be a parameter from which the (probable) (current and/or predicted) attitude of the offshore structure can be derived. In particular, these attitude parameters may be attitude parameters that directly influence the attitude of the offshore structure. According to a further embodiment of the offshore structure according to the application, the attitude parameter may be an environmental meteorological parameter (from which the actual current or future attitude parameter may be determinable). The at least one environmental meteorological parameter may be selected from the group comprising:
wind direction (measured or predicted),
wind strength (measured or predicted),
wave height (measured or predicted),
wave direction (measured or predicted).

These meteorological environmental parameters are particularly relevant to the attitude of an offshore structure.

In particular, it has been recognized that the aforementioned meteorological environmental parameters can influence the tilt angle (and thus the tilt movement) of the floatable offshore structure. For example, in the presence of a (current or predicted) swell and wave height, respectively, above a specific corresponding attitude parameter set point (e.g., a threshold with x m wave height), the length can be changed. It would be conceivable to increase the length to lift the offshore structure in such a way that the waves can roll under the structure. It would also be conceivable to shorten the length to improve the attitude by increasing the depth of the floating foundation. This may reduce the tilt angle. This in turn can increase the power yield.

Preferably, at least two, preferably all of said meteorological environmental parameters, can be determined and in particular provided. In particular, this at least one attitude parameter can be provided by at least one meteorological measuring device (e.g. measuring mast) of the offshore wind farm and/or a meteorological service. In further variants of the application, alternatively or additionally, at least one further meteorological environmental parameter (e.g. precipitation, solar radiation, etc.) can be provided.

According to a further embodiment of the offshore structure according to the application, the attitude stabilization device may (alternatively or additionally) comprise at least one ballast tank that can be filled with a ballast medium (preferably water, in particular seawater). Preferably, the at least one ballast tank may be integrated in the at least one foundation. Also, a ballast tank may be attached to the outer side of a foundation.

If two or more foundations and foundation elements, respectively, are provided, each foundation may have a ballast tank. The at least one ballast tank can in particular be arranged in such a way that filling/emptying leads to a specific vertical and/or horizontal alignment of the foundation. In the case of a plurality of ballast tanks, the filling/emptying may in particular be controlled so that a specific filling/emptying of the at least two ballast tanks may occur.

The attitude stabilization device may comprise at least one ballast medium conveying arrangement configured to change the filling level of the ballast tank, in particular in order to stabilize the attitude of the offshore structure.

The ballast medium conveying arrangement can be arranged in or on the foundation. By changing the filling level, in particular a vertical distance to the waterline respectively to the underwater ground surface is changed. This can stabilize the attitude of the offshore structure. In this embodiment, an attitude set point parameter can be a set point fill quantity (e.g., full, half-full, empty, x liters, etc.). According to a predetermined such attitude set point parameter, the ballast medium conveying arrangement can change the filling level of the ballast tank in order to change said vertical distance.

Particularly preferably, the ballast medium conveying arrangement can comprise at least one pumping device configured to change the filling level of the ballast tank by actively conveying the ballast medium into the ballast tank and/or by actively conveying the ballast medium out of the ballast tank. In particular, if active conveying of the ballast medium out of the ballast tank is provided, filling can be performed passively by opening a tank opening. In particular, if an active conveying of the ballast medium into the ballast tank is provided, an emptying can be performed passively by opening a tank opening. Preferably, however, at least one pumping device can be provided for both filling and emptying.

The setting of a specific filling level can be controlled by the control module. A level measuring element can be used to monitor the filling level. This allows a predetermined attitude set point parameter in the form of a set point fill quantity to be set in a reliable manner.

Alternatively or additionally, according to a further embodiment of the offshore structure according to the application, the attitude stabilization device may comprise at least one weight arrangement connected to the floatable foundation, which is changeable at least between a state lowered on the underwater ground surface and a state lifted from the underwater ground surface, for example by a suitable lifting device.

In particular, the weight arrangement may comprise a weight connection (e.g., an anchor rope and/or an anchor chain) that may be connected to the foundation. The other end of the weight connection may be connected to a weight element of the weight arrangement. In a lowered state, the weight element may be at least put down and lowered, respectively, on the underwater ground surface. In this state, in particular, almost no weight force can be exerted on the foundation by the at least one weight element of the weight arrangement.

In a lifted state, the weight element can be lifted off the underwater ground surface, i.e. (almost) no longer contacting it. In this state, in particular, a weight force (corresponding to the weight of the weight element of the weight arrangement) is exerted on the foundation by the at least one weight element of the weight arrangement. By an adjustment between said states, a change of said vertical distance can be effected and thereby the attitude of the offshore apparatus can be (positively) influenced.

In particular, in the case that a previously described ballast tank with a ballast conveying arrangement and/or a previously described weight arrangement is/are provided, according to a preferred embodiment of the offshore structure, the attitude stabilization device may comprise at least one tracking module configured to track the anchor connection (i.e. changing the length of the anchor connection), in particular in the case of a change in the vertical distance between a underwater ground surface of the underwater ground and the floatable foundation (or between the foundation and the waterline and water surface, respectively).

In order to prevent that a desired (minimum and/or maximum) tension between anchor and foundation will fall below or exceed, each anchor connection can in particular be coupled with a tracking module to track the anchor connection accordingly. In other variants, a tracking device can also be dispensed with.

The at least one attitude set point parameter can also be determined in such a way that the power yield is increased, in particular without the offshore structure getting into an unacceptable attitude. For example, as has been described, at least one minimum attitude set point parameter may be specified. The actual attitude of the offshore structure can then be set within the permissible range, in particular in such a way (for offshore wind turbines) that the energy yield of the offshore wind farm is maximized.

A further aspect of the application is an offshore system, in particular an offshore wind farm. The offshore system comprises a plurality of previously described offshore structures. The offshore system comprises at least one control apparatus configured to preset at least one attitude set point parameter for the plurality of offshore structures.

In particular, in an offshore wind farm it can be provided that the plurality of offshore wind turbines can be preset with different attitude set point parameters, at least in part. In particular, the attitude set point parameters can be determined in such a way that, on the one hand, they ensure a (predefined) sufficiently safe stable position and, on the other hand, they increase the overall energy yield of the offshore wind farm.

In particular, a (central) control apparatus (e.g. implemented as a software module in a central controller of the offshore wind farm) can be provided. The plurality of offshore wind turbines can be controlled via a communication network, for example by transmitting at least one control command containing at least one (previously described) attitude set point parameter.

According to a preferred embodiment of the offshore wind farm according to the application, the attitude set point parameter may additionally depend on the position of a first offshore wind turbine in relation to at least one further offshore wind turbine of the offshore wind farm. In other words, an attitude set point parameter may then be park position dependent.

Preferably, the attitude set point parameter used in controlling a specific offshore wind turbine may depend on the position of that offshore wind turbine within the offshore wind farm. For example, each offshore wind turbine may be associated with a park position attribute (e.g., a geographic indication of the offshore wind turbine, an indication of which row the offshore wind turbine is located with respect to a particular direction (e.g., main wind direction), and/or the like). For example, the turbine identifier of the offshore wind turbine may be stored together with the at least one park position attribute (indicating a park position) in a data memory arrangement that may be accessed by the control device.

In particular, it has been recognized that the electrical energy yield can be reduced if an offshore wind turbine is located in the lee of another offshore wind turbine under a specific meteorological environmental condition. By taking into account the respective park position of an offshore wind turbine according to the application, the energy yield can be increased, in particular in addition to ensuring a sufficiently safe attitude. For example, different vertical distances can be set for two offshore wind turbines arranged one behind the other (viewed in the current or predicted main wind direction) by means of corresponding attitude set point parameters and thus hub heights. This can increase the total yield of these two offshore wind turbines.

According to a further embodiment of the offshore system, in particular a wind farm, according to the application, at least a first meteorological environmental condition and a second meteorological environmental condition different from the first environmental condition may be specified. A meteorological environmental condition (and criterion, respectively) comprises in particular at least one meteorological environmental parameter range. During the evaluation, it can be checked whether a provided (previously described) meteorological environmental parameter lies in the at least one environmental parameter range or not. In other words, it can be checked whether the at least one meteorological environmental parameter (value) fulfills the at least one environmental condition or not.

In an assignment table, in particular for each environmental condition, each offshore wind turbine (and the corresponding turbine identifier, respectively) can be assigned (exactly) one attitude set point parameter (furthermore, selectable attitude set point parameters can be provided for special situations, as described before). The attitude set point parameters may, as explained, depend on the park position and the respective park position attribute, respectively, (and additionally define a minimum stable attitude). In particular, the assignment table may be stored in the data memory arrangement.

Upon detection of a specific meteorological environmental condition (in particular upon detection of a changed meteorological environmental condition (e.g., from the first to the second meteorological environmental condition or vice versa)), the control apparatus can access the stored assignment table and, in particular, control at least some of the offshore wind turbines of the offshore wind farm, preferably all of the offshore wind turbines of the offshore wind farm, according to the respective stored attitude set point parameters.

The attitude set point parameters that can be used for a controlling can be determined in advance. A determination in advance means in particular that the attitude set point parameters, in particular in the form of height set points, are not only determined when a specific meteorological environmental condition is detected (in particular when a changed meteorological environmental condition is detected (e.g. from the first to the second meteorological environmental condition or vice versa)), but are determined in terms of time prior to that.

In particular, prior to the installation of the offshore wind farm (for example, by means of a simulation model) and/or immediately after the installation (for example, by means of tests), the plurality of attitude set point parameters can be determined. Preferably, the attitude set point parameters can be stored in a variable way so that in particular an optimization can be performed during the operation of the offshore wind farm, in particular by evaluating the actual power yield (compared e.g. with a power yield determined by a simulation process).

According to a further embodiment of the offshore wind farm according to the application, the plurality of offshore wind turbines may be groupable at least into a first subgroup of offshore wind turbines each comprising an identical first park position attribute (corresponding to the respective park position, as previously set forth) and a second subgroup of offshore wind turbines each comprising an identical second park position attribute (corresponding to the respective park position, as previously set forth). The control apparatus may be configured to control the first subgroup of offshore wind turbines with attitude set point parameters different from the attitude set point parameters with which a second subgroup of offshore wind turbines is controlled. It shall be understood that a grouping may be made into three or more subgroups. The grouping may be (inherently) mapped in said assignment table. It shall be understood that the controlling is performed in particular upon detection of a specific environmental condition. Moreover, the grouping may depend on the environmental condition. In other words, a dynamic (rather than static) grouping into subgroups may be made.

A (in the at least one assignment table mappable and preferred) grouping strategy and height adjustment strategy, respectively, can preferably be to always increase the first row of offshore wind turbines (seen in wind direction) to a maximum height at which a sufficient stable position is still ensured. The second row can be set to the minimum height and then the third row again to the maximum height, etc. It would also be conceivable to always move the first row of offshore wind turbines (as seen in the wind direction) to a minimum height, set the second row to the maximum height, and then again the third row to the minimum height, and so on.

If further intermediate heights and/or a continuous adjustment of the distance and heights, respectively, are possible, other grouping strategies and height adjustment strategies, respectively can also be provided and, in particular, mapped in an assignment table respectively a database.

According to a particularly preferred embodiment of the offshore wind farm according to the application, the offshore wind farm may comprise at least one attitude set point determination device configured to (pre)determine the attitude set point parameters (to be used for controlling, in particular in the form of height set points) for controlling the plurality of offshore wind turbines depending on at least one measured or predicted meteorological environmental condition.

The attitude set point determination device can be configured to perform a plurality of simulation steps based in particular on a simulation model of the plurality of wind turbines of the offshore wind farm. In particular, a (mathematical) simulation model of the offshore wind farm can be created during planning and prior to an installation, with which in principle at least the generated total electrical power can be simulated depending on different meteorological environmental conditions and in particular with differently set vertical distances. Hereby, it can also be simulated which height can be set maximally or minimally without causing damages, for example due to the tilting movement. In this way, in particular, the at least one minimum attitude set point parameter can be determined. In other variants, the attitude set point determination device can alternatively or additionally be configured to perform tests.

In each simulation step (or test step), different attitude set points can preferably be set for the plurality of offshore wind turbines and the total electrical power generated for the attitude set points in each case can be determined. For example, the previously mentioned setting strategies can be simulated.

As attitude set points for (actually) controlling the plurality of offshore wind turbines at a specific meteorological environmental condition, the attitude set points can be determined (and in particular stored in the assignment table) at which the determined (simulated or tested) generated total electrical power is maximum (and sufficient stability of the respective offshore wind turbines is ensured). In other words, for preferably at least two different meteorological environmental conditions, the respective attitude set points at which at least the simulated (or tested) generated total electrical power is maximized can be determined by a simulation process (with a plurality of simulation steps).

Preferably, an optimization process can be performed during operation of the offshore wind farm. In particular, the actually generated total electrical power and the simulated (or tested) generated total electrical power can be evaluated. In particular, if the actual generated total electrical power is lower than the simulated generated total electrical power, the attitude set points can be adjusted (for example, using artificial intelligence) at least partially in order to increase the yield. Here, historical data and/or data from other offshore wind farms can be taken into account.

A further aspect of the application is a method for stabilizing the attitude of a floatable offshore structure, in particular a previously described floatable offshore structure, wherein the offshore structure comprises at least one anchoring arrangement configured to fix the offshore structure to an underwater ground in an anchoring state of the offshore structure, wherein the anchoring arrangement comprises at least one anchor connection extending between an anchor and the floatable foundation. The method comprises:
providing at least one attitude set point parameter and at least one attitude parameter of the offshore structure, and
changing the length of the anchor connection between the anchor and the floatable foundation in the anchoring state based on the attitude parameter of the offshore structure and the attitude set point parameter.

The method can be used in particular for operating, in particular controlling, a plurality of floating offshore wind turbines, i.e. in particular for operating, in particular controlling, an offshore wind farm described above.

A yet further aspect of the application is a floatable offshore set, comprising
at least a floatable foundation for an offshore structure, in particular an offshore structure described previously,
at least one anchoring arrangement comprising at least one anchor connection fixable to the floatable foundation, and
at least one attitude stabilization device in the form of a winch device couplable to the anchor connection and configured to wind and/or unwind an anchor connection coupled to the winch device based on at least one attitude parameter of the offshore structure and at least one attitude set point parameter.

It should be noted that a module, a device, etc. can be at least partially formed by software elements (in particular in the form of computer code executable by a processor) and/or at least partially by hardware elements (processor, memory means, actuator, etc.).

The features of the offshore structures, offshore systems (in particular offshore wind farms), methods and offshore sets can be freely combined with each other. In particular, features of the description and/or of the dependent claims may be independently inventive, even by completely or partially bypassing features of the independent claims, in sole position or freely combined with each other.

### BRIEF DESCRIPTION OF THE DRAWINGS

There is now a multitude of possibilities for designing and further developing the offshore structure according to the application, the offshore system according to the application, the process according to the application and the offshore set according to the application. For this purpose, reference is made on the one hand to the patent claims subordinate to the independent patent claims, and on the other hand to the description of embodiments in connection with the drawing. In the drawings:

FIG. 1a shows a schematic view of an embodiment of a floatable offshore structure according to the present application;

FIG. 1b shows a schematic view of a further embodiment of a floatable offshore structure according to the present application;

FIG. 1c shows a schematic view of a further embodiment of a floatable offshore structure according to the present application;

FIG. 1d shows a schematic view of a further embodiment of a floatable offshore structure according to the present application;

FIG. 2 shows a schematic view of a further embodiment of a floatable offshore structure according to the present application;

FIG. 3 shows a schematic view of a further embodiment of a floatable offshore structure according to the present application;

FIG. 4 shows an exemplary tilting movement of a floatable offshore structure plotted over time;

FIG. 5a shows a schematic view of a further embodiment of a floatable offshore structure according to the present application with a first set distance;

FIG. 5b shows a schematic view of the embodiment according to FIG. 5a with a further set distance;

FIG. 6a shows a schematic view of a further embodiment of a floatable offshore structure according to the present application with a first set distance;

FIG. 6b shows a schematic view of the embodiment according to FIG. 6a with a further set distance;

FIG. 7 shows a schematic view of an embodiment of an offshore system according to the present application; and

FIG. 8 shows a diagram of an embodiment of a method according to the present application.

### DETAILED DESCRIPTION

In the figures, the same reference signs are used for the same elements.

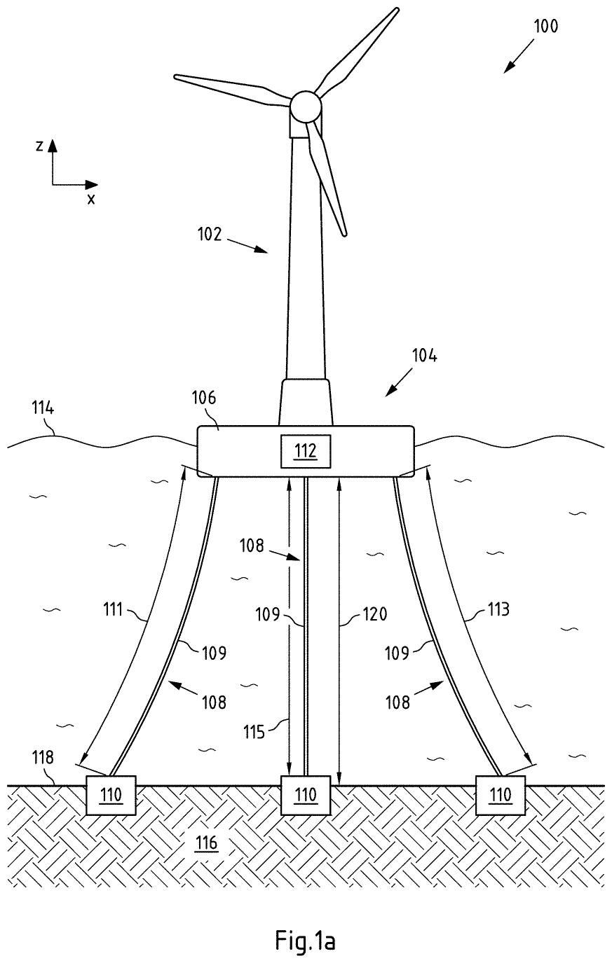

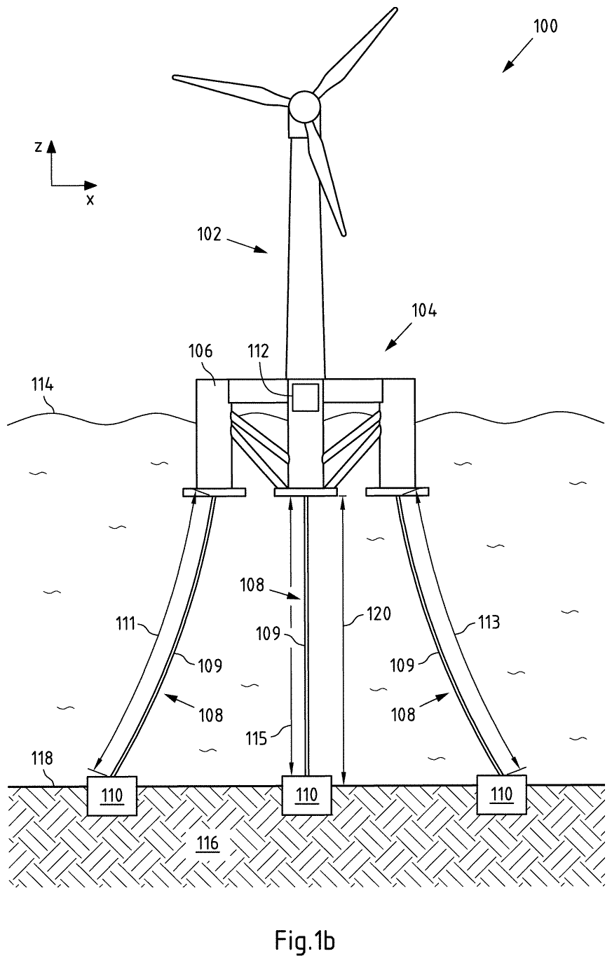

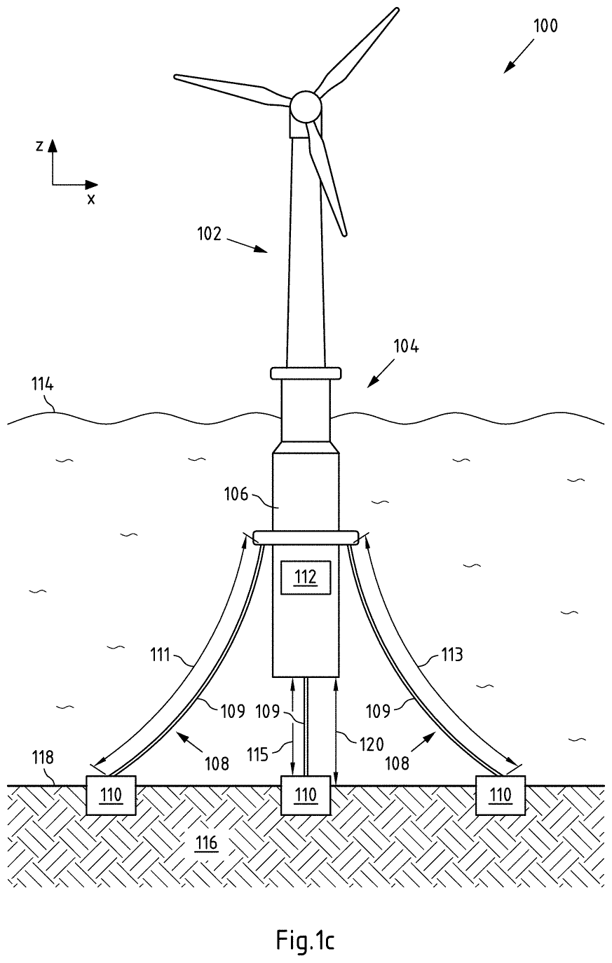

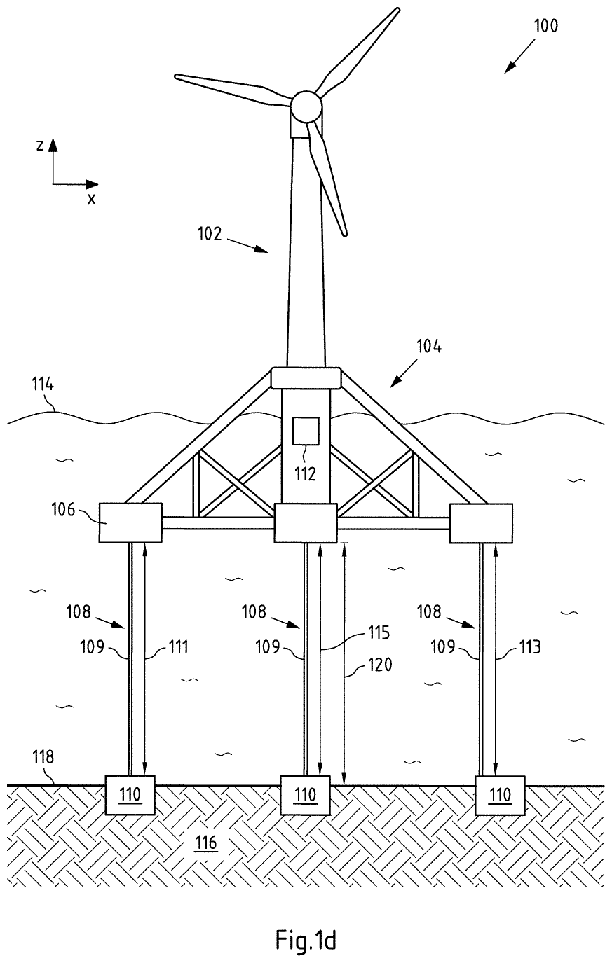

FIGS. 1a to 1d show schematic views of embodiments of floatable offshore structures 100 according to the present application. Exemplary offshore structures 100 are shown as offshore wind turbines 100. However, the following embodiments can be applied to other offshore structures.

The illustrated offshore wind turbines 100 differ in their respective floatable foundations 104, each comprising at least one floating body 106. In particular, a floatable foundation 104 at least substantially forms the floating body 106.

In particular, a barge foundation 104 (FIG. 1a), a semi-submersible foundation 104 (FIG. 1b), a spar foundation 104 (FIG. 1c), and a tension leg platform foundation 104 (FIG. 1d) are shown. It shall be understood that other floatable foundations may be provided in other variations of the application.

As can be seen, a wind power apparatus 102 comprising a tower, nacelle, rotor, generator, etc., is disposed on the at least one floatable foundation 104.

In the present embodiment, a floatable foundation 104 is respectively fixed and anchored, respectively, to the underwater ground 116 by means of a plurality of anchoring arrangements 108. An illustrated anchoring arrangement 108 comprises an anchor connection 109, in particular in the form of an anchor rope 109 or an anchor chain 109. One end of the anchor connection 109 is attached to the foundation 104 and the other end is attached to at least one anchor 110 (e.g., weight anchor, torpedo anchor, etc.). The anchor 100 may be at least partially buried in the underwater ground 116, as can be seen from FIGS. 1a to 1d.

Furthermore, in FIGS. 1a to 1d, the underwater ground surface is denoted with reference sign 118 and the water surface and waterline, respectively, is denoted with reference mark 114.

Furthermore, an offshore structure 100 according to the application comprises at least one attitude stabilization device 112 configured to change the length 111, 113, 115 of an anchor connection 109 between the anchor 110 and the floatable foundation 104 in the (illustrated) anchoring state based on at least one attitude parameter of the offshore structure 100 and at least one attitude set point parameter. As can be seen, the length 111, 113, 115 presently extends from the point of attachment of the anchor connection 109 with the anchor 110 and the point at which the anchor connection 109 enters the foundation 104.

Preferably, a plurality of different attitude parameters, e.g. in the form of an attitude parameter data set and a corresponding plurality of (predefined) attitude set point parameters, e.g. in the form of a corresponding attitude set point parameter data set, may be provided.

Preferably, the attitude stabilization device 112 may comprise at least one control module configured to control a changing of the length 111, 113, 115 of the anchor connection 109 between the anchor 110 and the floatable foundation 104 based on the at least one attitude parameter of the offshore structure 100 and at least one attitude set point parameter. In particular, this means that at least one of the lengths 111, 113, 115 is changed such that the (current and/or predicted future) attitude parameter (substantially) corresponds to the attitude set point parameter. In the event that the at least one attitude set point parameter is a limit value of an impermissible attitude range, variants of the application can provide that at least one of the lengths 111, 113, 115 is changed in such a way that the (current and/or predicted future) attitude parameter lies at least in the permissible attitude range, i.e. does not exceed (or fall below) the attitude set point (limit) parameter.

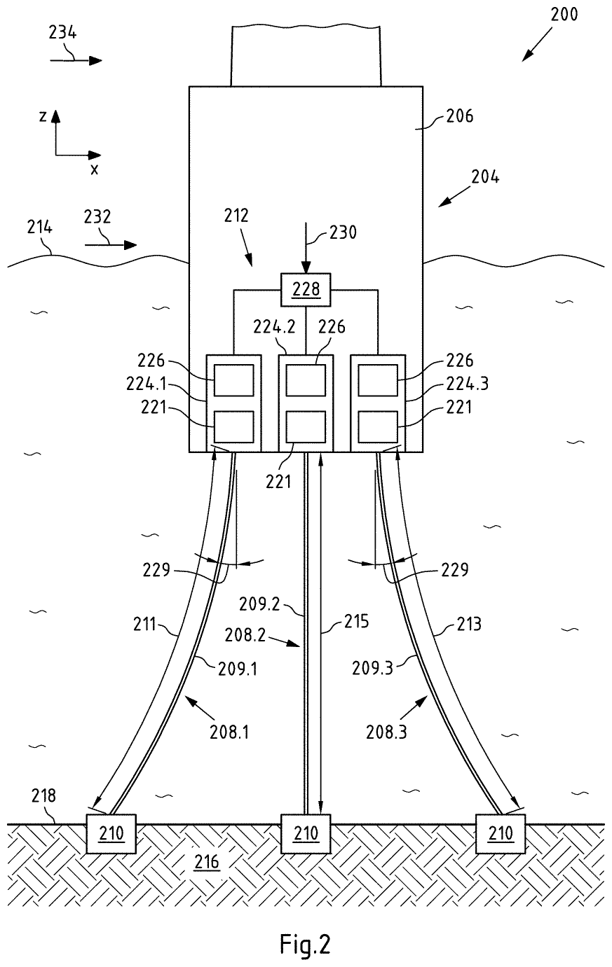

FIG. 2 shows a schematic view of a further embodiment of a floatable offshore structure 200 according to the present application. In order to avoid repetitions, essentially only the differences to the previous embodiments according to FIGS. 1a to 1d are described. Otherwise, reference is made to the previous explanations.

The offshore structure 200 comprises an attitude stabilization device 212. In the present embodiment, the attitude stabilization device 212 comprises at least one winch device 224.1, 224.2, 224.3 and three winch devices 224.1, 224.2, 224.3. In particular, each anchoring arrangement 208.1, 208.2, 208.3 may be associated with a winch device 224.1, 224.2, 224.3. Preferably, each anchor connection 209.1, 209.2, 209.3 may be coupled to a respective winch device 224.1, 224.2, 224.3. In particular, an anchor connection 209.1, 209.2, 209.3 may be coupled to a cylindrical drum (winch) of a winch device 224.1, 224.2, 224.3 to wind and unwind the anchor connection 209.1, 209.2, 209.3 between a minimum and a maximum length.

For this purpose, each winch device 224.1, 224.2, 224.3 may comprise a drive 226 and a parking brake 221. In order to change a length 211, 213, 215, a control module 228 of the position stabilization device 212 can first control the corresponding parking brake 221 to cause a release of this parking brake 221. Then, the control module 228 may control the corresponding drive 226 (preferably an electric motor 226) to cause winding or unwinding by a specified length. The parking brake may then be locked again, controlled by the control module 228.

At least one attitude set point parameter (value), preferably an attitude set point parameter set, may be provided to the control module 228 via an input 230. In a corresponding manner, at least one attitude parameter (value), in particular an attitude parameter set, of the offshore structure 200 may be provided. For example, an actual attitude parameter may be provided. Then, the control module 228 may change the length 211, 213, 215 of at least one anchoring arrangement 208.1, 208.2, 208.3 such that the at least one attitude set point parameter is fulfilled by the at least one actual attitude parameter.

In FIG. 2, the reference sign 234 denotes the (current) main wind direction and the reference sign 232 denotes the (current) main wave direction (usually these directions 232, 234 can be nearly identical).

As can further be seen from FIG. 2, at least one vertical anchor connection 209.2 extending in a substantially vertical direction may be attached to the floatable foundation 204. At least one angle anchor connection 208.1, 208.3 extending at an angle 229 to the vertical direction of at least 2°, preferably at least 5° (and at most) 45°, may be attached to the floatable foundation 204. The position stabilization device 212 may be configured to change the length of the vertical anchor connection 208.2 and/or the angle anchor connection 208.1, 208.3 based on at least one attitude parameter of the offshore structure 200. In particular, depending on the at least one attitude parameter and the at least one attitude set point parameter, it may be advantageous if the respective lengths of the vertical anchor connection 208.2 and the at least one angle anchor connection 208.1, 208.3 are changed differently.

If in particular the vertical plane, in which the angle 229 of the angle anchor connection 208.1, 208.3 lies with respect to the vertical direction, extends in a direction parallel (±20°) to the main wind direction (±20°) and/or main wave direction (±20°) and in particular the anchor 210 of said angle anchor connection 208.1 is located on the wind- and/or wave-impinging side, it can be predefined, in particular by the at least one attitude set point parameter that the anchor connection of said angle anchor connection 208.1 is shortened more (e.g. 2 to 10 m more) than the at least one vertical anchor connection 208.2, in particular in such a way that without wind and waves an inclination in the direction of the main wind direction 234 and/or main wave direction 232 would result. Additionally or alternatively, it may be provided that at least one further angle anchor connection 208.3, for which the anchor 210 is located on the side facing away from the wind and/or waves, is left unchanged or extended such that, in the absence of wind and waves, an inclination in the direction of the main wind direction 234 and/or main wave direction 232 would result.

As can be further seen from FIG. 2, in particular an offshore set is provided comprising at least one floatable foundation 204 for an offshore structure 200, at least one anchoring arrangement 208 having at least one anchor connection 209 attachable to the floatable foundation 204, and at least one attitude stabilizing device 212 in the form of a winch device 224 that can be coupled to the anchor connection 224.1, 224.2, 224.3 configured to wind and/or unwind an anchor connection 209.1, 209.2, 209.3 coupled to the winch device 224.1, 224.2, 224.3 based on at least one attitude parameter of the offshore structure 200 and at least one attitude set point parameter.

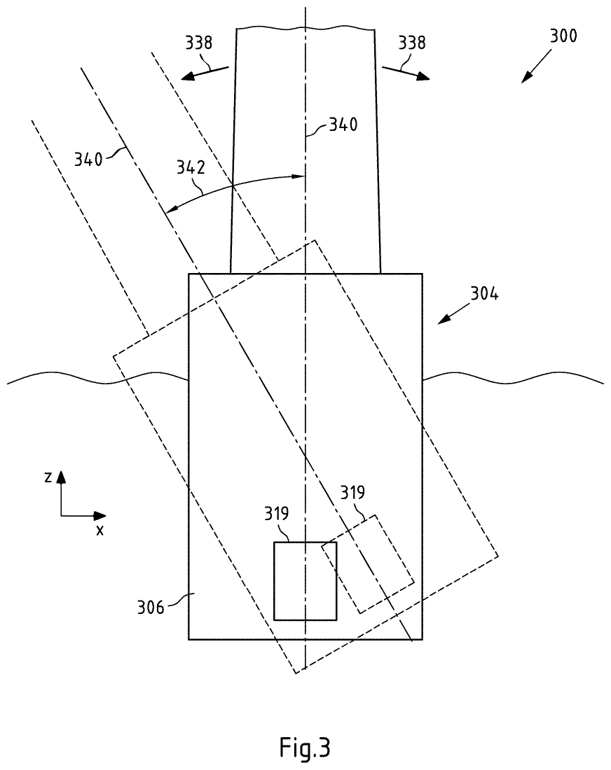

FIG. 3 shows a schematic view of a further embodiment of an offshore structure 300 according to the present application. In order to avoid repetitions, essentially only the differences to the previous embodiments according to FIGS. 1a to 2 are described below and otherwise reference is made to the previous explanations. It should be noted that only for the sake of a better overview an illustration of the entire offshore apparatus, anchoring arrangements, control modules etc. has been omitted.

In particular, in FIG. 3, a tilting movement and swaying movement, respectively, (indicated by the arrow 338) of the floating offshore structure 300 is indicated. Thus, in the dashed version, the offshore structure 300 is shown at the reversal point of the tilting movement, that is, when the tilt angle 342 is at a maximum. In addition, the offshore structure 300 is shown in the vertical state.

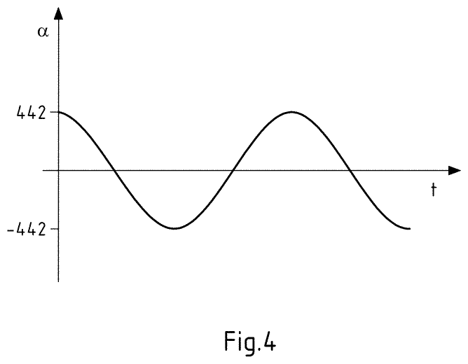

The temporal course of the tilt angle a between the maximum tilt angles—442, 442 is shown in FIG. 4. As can be seen from FIG. 4, the curve is essentially sinusoidal.

The offshore structure 300 comprises at least one attitude detecting device 319 (with at least one suitable attitude sensor) configured to detect the at least one attitude parameter of the offshore structure 300. In other words, in this embodiment, the offshore structure 300 can in particular determine at least one actual attitude parameter of the offshore structure 300 by the attitude detecting device 319, itself. In particular, a control of a winch device or another device (e.g., ballast medium conveying arrangement, lifting device), in particular of the at least one drive, can be performed depending on a difference between the detected attitude parameter and actual attitude parameter, respectively, and the (predetermined) attitude set point parameter. It shall be understood that an actual attitude parameter data set and a corresponding attitude set point parameter data set can be provided.

In particular, the at least one attitude parameter may be at least one attitude angle (also called Euler angle) of the offshore structure 300. For example, the at least one attitude parameter may be a yaw angle (angle between the current orientation of the offshore structure 300 and the vertical axis (also referred to as the z-axis)), a roll angle (angle between the current orientation of the offshore structure 300 and a longitudinal axis (also referred to as the x-axis)) and/or a pitch or pitch angle (angle between the current orientation of the offshore structure 300 and a longitudinal axis (also referred to as the y-axis)).

Preferably, the attitude detecting device 319 may be a tilt angle detecting device 319 configured to detect the (maximum) tilt angle 342 of the offshore structure 300. As shown, the tilt angle 342 is in particular the (maximum) angle 342 related to a vertical axis 340 and direction z, respectively, during a tilting movement or swaying movement 338 of the offshore structure 300. For example, a (maximum) tilt angle 342, preferably a permissible tilt angle range, may be provided as an attitude set point parameter. If the actual tilt angle 342 is outside the permissible tilt angle range, in particular the length can be changed in such a way (in particular for such a long time) that (until) the detected tilt angle 342 is again within the permissible range.

Alternatively or additionally, the attitude detecting device 319 may be a tilt frequency detecting device 319 configured to detect the tilt frequency (fₖᵢₚₚ=1/Tₖᵢₚₚ, see FIG. 4) of the offshore structure 300. It shall be understood that detecting the tilt frequency fₖᵢₚₚ includes detecting the tilt period duration Tₖᵢₚₚ. Analogous to the discussion of the tilt angle, a control can be performed.

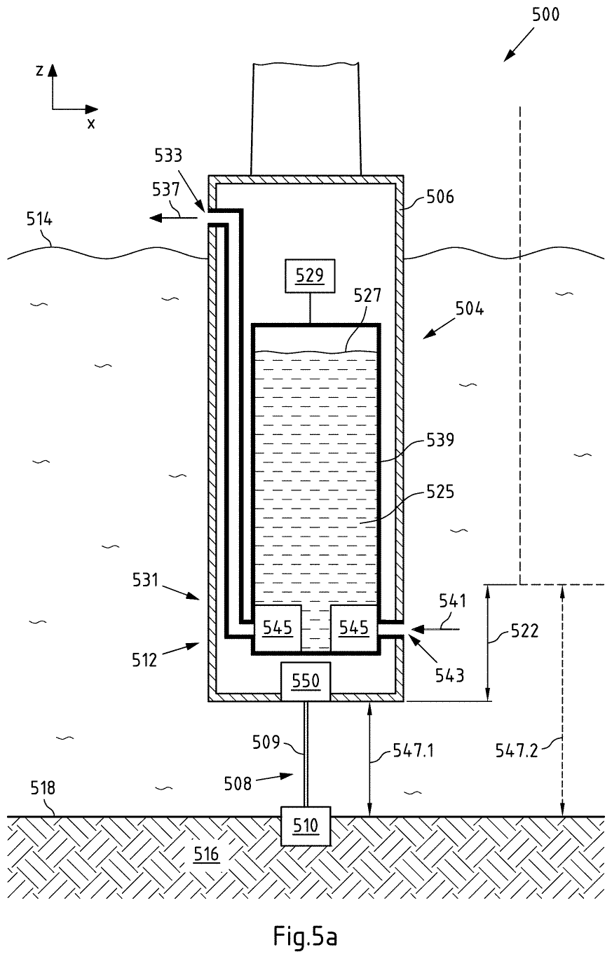

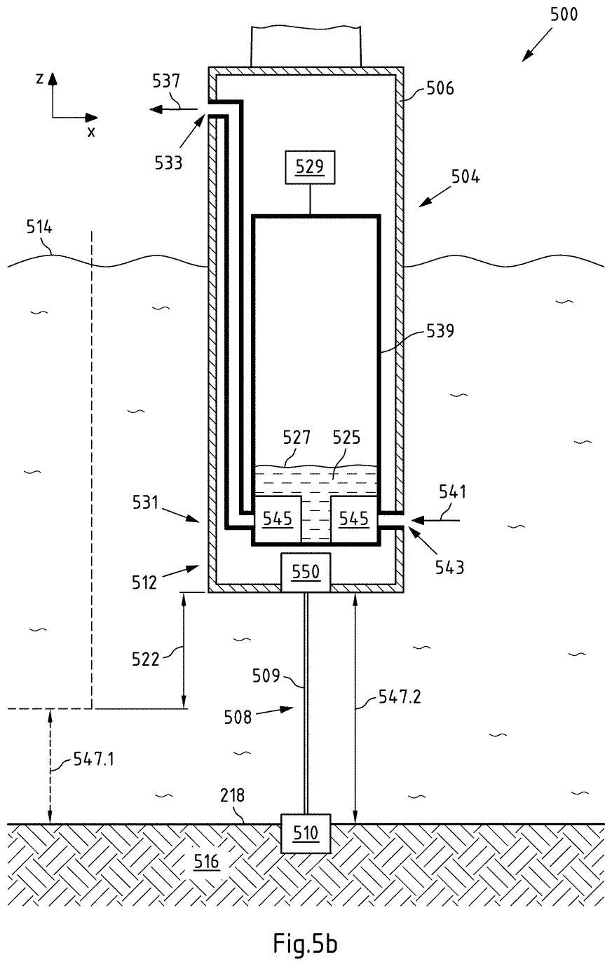

FIGS. 5a and 5b show a further embodiment of a floatable offshore structure 500 with differently set vertical distances 547.1, 547.2. In order to avoid repetitions, essentially only the differences from the previous embodiments according to FIGS. 1a to 4 are described below and otherwise reference is made to the previous explanations. It should be noted that only for the sake of a better overview a representation of the entire wind power device has been omitted.

The difference between the distances 547.1, 547.2 in FIGS. 5a and 5b is denoted with reference sign 522. The settable difference can preferably be between 10 m and 40 m.

For setting the vertical distance 547.1, 547.2 (to the underwater ground surface (and to the waterline, respectively)), an attitude stabilization device 512 is provided in the present case. The illustrated attitude stabilization device 512 comprises at least one ballast tank 539 which can be filled with a ballast medium 525 and is preferably arranged in the foundation 504. Furthermore, the attitude stabilization device 512 comprises at least one ballast medium conveying arrangement 531, which is in particular configured to change the filling level 527 of the ballast tank 539.

In particular, the ballast medium conveying arrangement 531 comprises two pumping devices 545. In particular, one pumping device 545 is configured to change the filling level 527 of the ballast tank 539 by actively pumping the ballast medium 525 (in particular water) into the ballast tank 539 (indicated by the arrow 541). In particular, an opening 543 may be arranged in the foundation 504 through which the ballast medium 525 can be pumped into the ballast tank 539.

In particular, the further pumping device 230 is configured to change the filling level 527 of the ballast tank 539 by actively pumping the ballast medium 525 out of the ballast tank 539 (indicated by the arrow 537). In particular, a further opening 533 may be arranged in the foundation 504 through which the ballast medium 525 may be pumped out of the ballast tank 539.

Preferably, a control module 528 may be provided. The (local) control module 528 of the attitude stabilization device 512 can, for example, be controllable by a (not shown) control apparatus with an attitude set point parameter (e.g. a specific filling quantity (e.g. full, half full, empty, x liters etc.) or the like). Preferably, a minimum attitude set point parameter can be stored locally.

Depending on a current filling level 527 measurable by a (not shown) filling level measuring element of the control module 528 and a received height set point, a pumping device 545 can be controlled in such a way that the filling level 527 is changed according to the attitude set point parameter. In particular, by changing the vertical distance 547.1, 557.2, the attitude of an offshore structure 500 can be stabilized. In addition, this can in particular increase the power yield.

The attitude stabilization device 512 may further comprise at least one tracking module 551 configured to track (i.e., change the length of) the anchor connection 509, in particular when the vertical distance 547.1, 547.2 between an underwater ground surface 518 of the underwater ground 516 and the floatable foundation 504 changes. In particular, in order to prevent a desired (minimum and/or maximum) tension between the anchor 510 and the foundation 504 falls below or exceeds, each anchor connection 509 may be coupled to a tracking module 551 to track the anchor connection 509 accordingly.

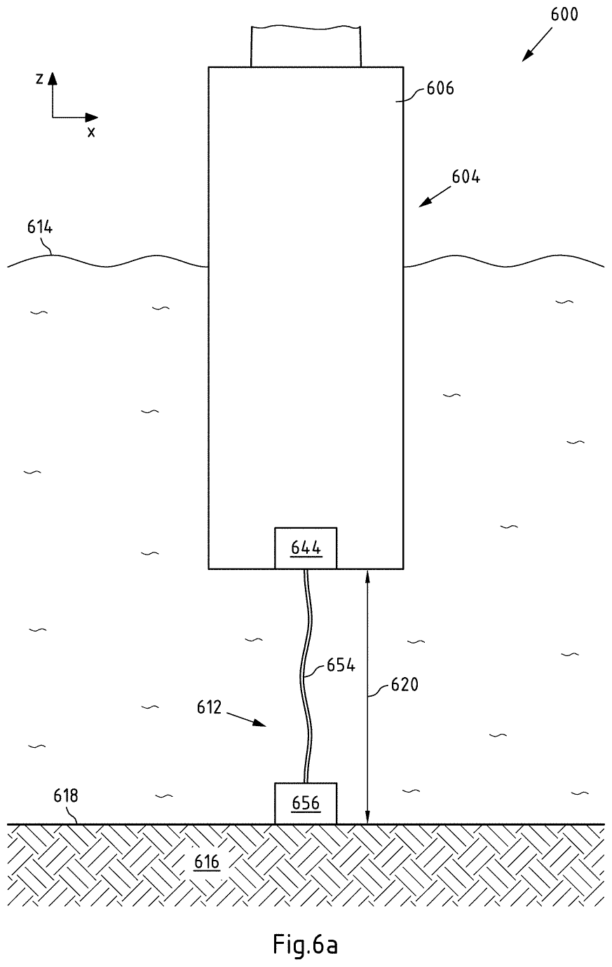

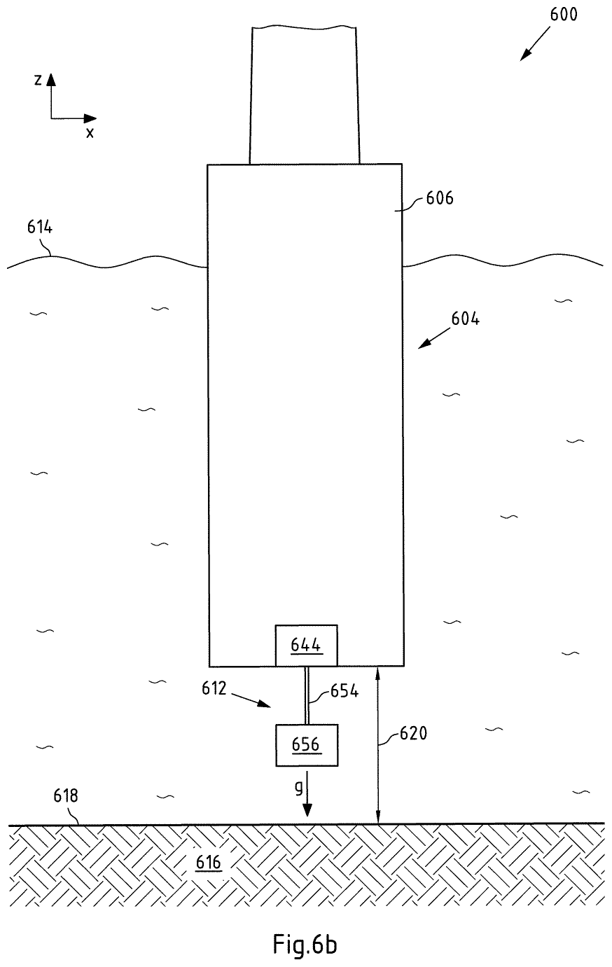

FIGS. 6a and 6b show a further embodiment of a floatable offshore structure 600 with differently set vertical distances 647.1, 647.2. In order to avoid repetitions, essentially only the differences to the previous embodiments according to FIGS. 1a to 5b are described below and otherwise reference is made to the previous explanations. It should be noted that only for the sake of a better overview a representation of the entire wind power device and the representation of anchoring arrangements (and tracking modules) has been omitted.

In the present embodiment, the attitude stabilization device 612 comprises at least one weight arrangement 612 connected to the floatable foundation 604. In particular, the weight arrangement 612 may comprise a weight connection 654 (e.g., an anchor cable 654 and/or an anchor chain 654) that may be connected to the foundation 604. The other end of the weight connection 654 may be connected to a weight element 656 of the weight arrangement 612.

In a lowered state of the weight arrangement 612, in particular almost no weight force is exerted on the foundation 640 by the at least one weight element 656 of the weight arrangement 612. In a lifted state of the weight arrangement 612, for example caused by a lifting device 658 (e.g. a winch 658), in particular a weight force g (corresponding to the weight of the weight element 656 of the weight arrangement) is exerted by the at least one weight element 656 of the weight arrangement 612 on the foundation 604. By a setting, by the lifting device 658, between said states of the weight arrangement 612, a change of said vertical distance 647.1, 647.2 can be caused at least between two discrete values.

Again, a control module (not shown) may be provided that can control the lifting device 658 depending on a received attitude set point parameter (e.g., lowering or not lowering).

It shall be understood that the embodiments according to FIGS. 2, 5a, 5b and/or 6a, 6b can be combined with each other.

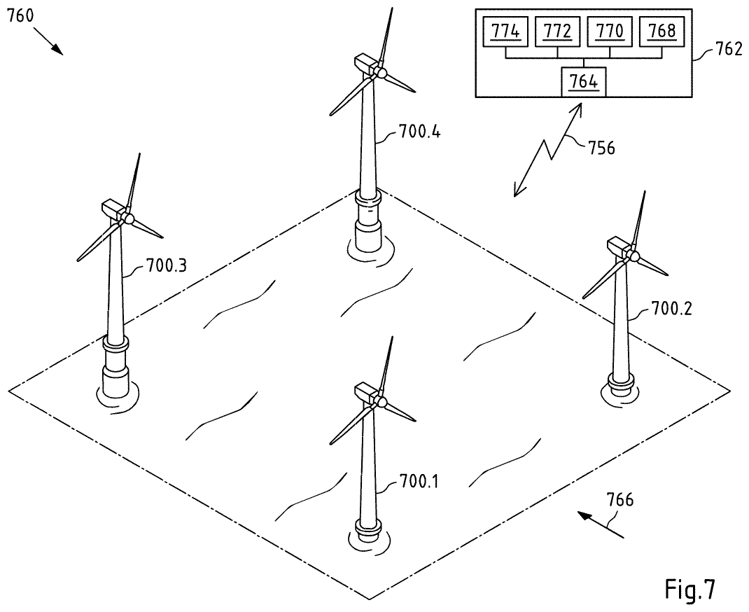

FIG. 7 shows a schematic view of an embodiment of an offshore system 760. An offshore wind farm 760 is shown as an example. In the following embodiments, at least one attitude set point parameter may be provided and, in particular, predetermined by a control apparatus 762. It may be provided that the at least one attitude set point parameter, preferably at least two selectable different attitude set point parameters (data sets), are stored locally and in advance in an offshore structure 700.1-700.4. For example, it may be provided that at least one minimum attitude set point parameter (data set) is stored locally in each offshore structure 700.1-700.4. This can ensure that a specific minimum stable position of the offshore structure 700.1-700.4 is always maintained. The actual attitude of the offshore structure 700.1-700.4 can then be set within the permissible range (variable, in particular yield-optimized), in particular in such a way (for offshore wind turbines 700.1-700.4) that the energy yield of the offshore wind farm is maximized. Due to the minimum attitude parameter (data set) it is ensured that a sufficiently stable position of each offshore wind turbine 700.1-700.4 is always maintained.

In the following, it is assumed that a minimum attitude set point parameter (data set) is predefined and additionally, depending on meteorological environmental conditions, attitude set point parameters, in particular in the form of height set points, are predefined by the control apparatus 762 of the offshore wind farm 760. This presetting is described in more detail below.

For example, the control apparatus 762 may be implemented in a (anyway provided) (not shown) park control system of the offshore wind farm 760.

In the present embodiment, the control device 762 includes a communication module 764, an altitude control module 768, a detecting device 770, an altitude set point determination device 772, and a data memory arrangement 774. It shall be understood that other variants may provide additional or fewer modules/devices.

The height set point determination device 772, which may alternatively be implemented in another computing device, may be configured to determine at least the height set points depending on at least one environmental meteorological condition (at the installation site of the offshore wind farm 760).

Preferably, the determination may be performed prior to the installation of the offshore wind farm 760, but may also be performed during the installation and/or (immediately) after the installation of the offshore wind farm 760. As has been explained, an optimization process may take place (continuously) during operation.

Preferably, a determination of attitude set point parameters in the form of height set point values for preferably all offshore wind turbines 700.1 to 700.4 can be performed.

In particular, the respective determined height set point may depend on the (park) position of the respective offshore wind turbine 700.1 to 700.4, in particular in relation to at least one further offshore wind turbine 700.1 to 700.4 of the offshore wind farm 760. For example, a plan and/or a model of the offshore wind farm 760 may be stored (for example, in the data memory arrangement 774 or another memory arrangement), in which a park position attribute is assigned to each offshore wind turbine 700.1 to 700.4. From the respective park position attribute, the park position is at least derivable. In particular, the respective park position attribute can be used to (dynamically) form at least two subgroups of offshore wind turbines 700.1 to 700.4. In particular, this means that the offshore wind turbines 700.1 to 700.4 of a subgroup are set to essentially the same vertical distance, i.e. are controlled with essentially the same height set point. In particular, the grouping can be (inherently) mapped in an assignment table and database, respectively.

The at least one height set point determination device 772 may be configured to (pre) determine the height set points for controlling the plurality of offshore wind turbines 700.1 to 700.4 depending on at least one measured or predicted meteorological environmental condition. The height set point determination device 772 may be configured to perform a plurality of simulation steps based in particular on a simulation model of the plurality of wind turbines 700.1 to 700.4 of the offshore wind farm 760. In other variants of the applications, actual tests may also be performed to determine the power yield, as described above.

In particular, a (mathematical) simulation model of the offshore wind farm 760 can be created during planning and prior to an installation, with which in principle at least the generated total electrical power can be simulated and in particular determined depending on different meteorological environmental conditions and in particular with differently set vertical distances/locations.

In each simulation step, different height set points can preferably be set for the plurality of offshore wind turbines 700.1 to 700.4 and the total electrical power generated for each of the height set points can be determined.

As height set points, i.e., position set point parameter(s), for (actually) controlling the plurality of offshore wind turbines 700.1 to 700.4 at the environmental meteorological condition, the height set points can be determined and, in particular, stored in an assignment table in the data memory arrangement 774 at which the determined generated total electrical power is maximum.

For preferably at least two different meteorological environmental conditions, the respective height set points at which at least the simulated generated total electrical power is maximized can be determined by a simulation process (with a plurality of simulation steps). In the assignment table, a height set point can be assigned to each (given) environmental condition for each offshore wind turbine 700.1 to 700.4.

In particular, by determining the height set points, a grouping strategy and height adjustment strategy, respectively, can be specified and mapped. For example, the first row of offshore wind turbines 700.1, 700.2 in the wind direction (i.e. at a specific detected environmental condition) can always be controlled in such a way that the vertical distance is maximized (i.e. the hub height is maximized). The second row of offshore wind turbines 700.3, 700.4 in the wind direction (i.e. at a specific detected environmental condition) can be controlled in such a way that the vertical distance is minimized (i.e. the hub height is minimized). In other variants, the setting can also be exactly the opposite. If further intermediate heights and/or a continuous adjustment of the distance or heights are possible, other grouping strategies and height adjustment strategies, respectively, can also be provided.

In operation, the offshore wind farm 760 a providing of at least one specific meteorological environmental parameter of the offshore wind farm 760 may be performed. In particular, the at least one meteorological environmental parameter may be provided to the control apparatus 762 via the communication module 764. The at least one specific environmental meteorological parameter may be a current environmental meteorological parameter measured by at least one measurement device and/or a predicted environmental meteorological parameter. Preferably, a plurality of environmental meteorological parameters (measured and predicted) may be provided, such as wind direction (measured and/or predicted), wind strength (measured and/or predicted), wave height (measured and/or predicted), and wave direction (measured and/or predicted).

By means of the detecting device 770, in particular, it can be detected whether at least one of the (predetermined) meteorological environmental conditions is fulfilled by the at least one specific and provided meteorological environmental parameter. In particular, a meteorological environmental condition (and criterion, respectively) comprises at least one meteorological environmental parameter range. During detection, it may be verified whether or not the meteorological environmental parameter is within the at least one environmental parameter range. In other words, it may be checked whether or not the at least one environmental meteorological parameter (value) fulfils the at least one environmental condition.

In particular, it can be detected whether the meteorological environmental condition has changed so that a change in the vertical distances/attitudes should be made. If it is determined that the meteorological environmental condition has not changed, in particular no change in the vertical distances is required.

In particular, upon a detection that the environmental meteorological condition has changed from a previously detected environmental meteorological condition, for example from a first to a second environmental meteorological condition (e.g., the wind strength and/or wind direction may have changed or is changed to an extent specified by the defined environmental conditions), by the height control module 768 a controlling of at least one attitude stabilization device of an offshore wind turbine 700.1 to 700.4 is performed with a height set point and attitude set point parameter, respectively, for causing a change, in particular a vertical distance of the floatable foundation of the offshore wind turbine 700.1 to 700.4 to the underwater ground surface corresponding to the height set point. In particular, at least each offshore wind turbine 700.1 to 700.4 for which a change of the vertical distance is to be effected can be controlled.

Preferably, the height control module 768 can access the described assignment table stored in the data memory arrangement 774 in order to determine and read, respectively, the height set points (and attitude set points, respectively) to be used for controlling. Then, the height control module 768 may cause a sending of respective control commands, each containing at least one height set point (described previously). The control commands may be transmitted to the respective offshore wind turbines 700.1 to 700.4 via the communication module 764 and the communication network 756. The respective attitude stabilization devices can then—in a previously described manner—adjust the vertical distance and the vertical attitude, respectively.

In particular, depending on the wind direction, the individual heights of the wind turbine hubs can be set such that the yield is maximized. As already described, conceivable height settings are continuous or discrete, e.g. by means of two or three preset heights.

In addition, it can be provided that in case of too strong wind and/or too strong waves (given by e.g. a third meteorological environmental condition) all offshore wind turbines 700.1 to 700.4 reduce their vertical distance, in particular minimize it, because the nominal power is reached and/or to avoid damages.

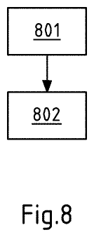

FIG. 8 shows a diagram of an embodiment of a method according to the present application for stabilizing the position of a floatable offshore structure, in particular a floatable offshore structure according to one of the previous embodiments, wherein the offshore structure comprises at least one anchoring arrangement configured to fix the offshore structure to an underwater ground in an anchoring state of the offshore structure, wherein the anchoring arrangement comprises at least one anchor connection extending between an anchor and the floatable foundation.

In a step 801, at least one attitude set point parameter and at least one attitude parameter of the offshore structure are provided. In step 802, the length of the anchor connection between the anchor and the floatable foundation is changed in the anchoring state based on the attitude parameter of the offshore structure and the attitude set point parameter.

It shall be understood that when a winch device is used, it may be necessary to embed an anchor deeper in the underwater ground and/or increase the weight of the anchor (compared to when no winch device is provided).

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A floatable offshore structure, comprising:
at least one floatable foundation comprising at least one floating body, and
at least one anchoring arrangement configured to fix the offshore structure to an underwater ground in an anchoring state of the offshore structure,
wherein the anchoring arrangement comprises at least one anchor connection extending between an anchor and the floatable foundation,
at least one attitude stabilization device configured to change the length of the anchor connection between the anchor and the floatable foundation in the anchoring state based on at least one attitude parameter of the offshore structure and at least one attitude set point parameter,
at least one substantially vertically extending vertical anchor connection is attached to the floatable foundation, and
at least one angle anchor connection extending at an angle to the vertical direction of at least 2°, preferably at least 5°, is attached to the floatable foundation, wherein the length of the vertical anchor connection is changeable,
wherein the attitude stabilization device is configured to change the length of the vertical anchor connection and the angle anchor connection based on at least one attitude parameter of the offshore structure, wherein the length of the angle anchor connection is changeable,
wherein the respective length of the vertical anchor connection and of the angle anchor connection are differently changeable.

2. The offshore structure of claim 1, wherein
the attitude stabilization device comprises at least one winch device coupled to the anchor connection configured to change the length of the anchor connection between the anchor and the floatable foundation.

3. The offshore structure of claim 2, wherein
the winch device comprises at least one parking brake,
wherein the parking brake is releasable to change the length of the anchor connection.

4. The offshore structure of claim 1, wherein
the offshore structure comprises at least one attitude detecting device configured to detect the at least one attitude parameter of the offshore structure.

5. The offshore structure of claim 4, wherein,
the attitude detecting device is a tilt angle detecting device configured to detect the tilt angle of the offshore structure,
and/or
the attitude detecting device is a tilt frequency detecting device, configured to detect the tilt frequency of the offshore structure.

6. The offshore structure of claim 1, wherein
at least a first selectable attitude set point parameter for a first position state of the offshore structure and a second selectable attitude set point parameter for a second attitude state of the offshore structure are provided,
wherein the first attitude state is different from the attitude position state.

7. The offshore structure of claim 1, wherein
the attitude parameter is an attitude parameter determinable from an environmental meteorological parameter, and
the at least one environmental meteorological parameter is selected from the group comprising:
wind direction,
wind strength,
wave height,
wave direction.

8. The offshore structure of claim 1, wherein
the attitude stabilization device comprises at least one ballast tank fillable with a ballast medium, and
the attitude stabilization device comprises at least one ballast medium conveying arrangement configured to change the filling level of the ballast tank.

9. The offshore structure of claim 1, wherein
the attitude stabilization device comprises at least one weight arrangement connected to the floatable foundation, wherein the weight arrangement is changeable between at least a state lowered on the underwater ground surface and a state lifted from the underwater ground surface.

10. The offshore structure of claim 1, wherein
the attitude stabilization device comprises at least one tracking module configured to track the anchor connection upon a change in a vertical distance between an underwater ground surface of the underwater ground and the floatable foundation.

11. An offshore system, comprising:
a plurality of offshore structures of claim 1; and
at least one control apparatus configured to preset at least one attitude set point parameter for the plurality of the offshore structures.

12. A method for stabilizing the attitude of a floatable offshore structure of claim 1, wherein the offshore structure comprises at least one anchoring arrangement configured to fix the offshore structure to an underwater ground in an anchoring state of the offshore structure, wherein the anchoring arrangement comprises at least one anchor and a floatable foundation of the offshore structure, the method comprising:
providing at least one attitude set point parameter and at least one attitude parameter of the offshore structure, and
changing the length of the anchor connection between the anchor and the floatable foundation in the anchoring state based on the attitude parameter of the offshore structure and the attitude set point parameter.

13. A floating offshore set, comprising:
at least one floatable foundation for an offshore structure of claim 1,
at least one anchoring arrangement comprising at least one anchor connection attachable to the floatable foundation, and
at least one attitude stabilization device in the form of a winch device couplable to the anchor connection and configured to wind and/or unwind the anchor connection coupled to the winch device based on at least one attitude parameter of the offshore structure and at least one attitude set point parameter.

14. The offshore structure of claim 1, wherein the offshore structure is a floatable offshore wind turbine.

15. The offshore system of claim 11, wherein the offshore system is an offshore wind farm.
